(19) United States
(12) Patent Application Publication
(10) Pub. No.: US 2008/0171631 A1
(43) Pub. Date: Jul. 17, 2008

(54) Lubricant-infusing device for linear actuator

(75) Inventor: Fu-Yuan Cheng, Taichung (TW)

Correspondence Address: CHARLES E. BAXLEY, ESQ., 90 JOHN STREET, THIRD FLOOR, NEW YORK, NY, 10038, US

(73) Assignee: Hiwin Mikrosystem Corp.

(21) Appl. No.: 11/589,634

(22) Filed: Oct. 30, 2006

(51) Int. Cl. B60W 10/10

(52) U.S. Cl. 477/34

(57) ABSTRACT

The concept of the present invention can be applied to a transmission system which is comprising a power device, a driving link and a driven system wherein the driving link is operatively connected to the power device and for transmitting the motive power generated by the power device to the driven system. A lubricant-infusing device according to the present invention comprises at least one lubricant-infusing point provided on the driving link at a location adjacent to the power device wherethrough a lubricant can be infused to offer lubricant and cooling functions to the mechanism of the driven system.

### BACKGROUND OF THE INVENTION

1. Technical Field

The present invention relates to linear actuators, and more particularly, to a lubricant-infusing device equipped to a linear actuator that allows lubricant to be infused into the linear actuator.

2. Description of Related Art

Over-heat and noise are general operational problems of conventional linear actuators. As such conventional linear actuators are typically composed of plastic steel or metal materials, when operating with high load or high activity rate, the plastic steel components thereof may get soften due to high-heat and in turn make related machine parts damaged during operation or buzzes may occur due to the impact or friction among the metal components.

Meantime, the resistance to the mechanical operation derived from undesirable friction may not only cause energy waste but also detrimentally burden the linear actuators over long term operation.

To dodge foresaid problems about over-heat, operational noise and undesirable mechanical friction, current linear actuators are usually programed with a relatively low activity rate, for instance, 10% to 25%. As a result, though the foresaid mechanical problems can be overcome, the operational efficiency of the linear actuators is therefore restricted and not capable of achieving the maximum efficiency thereof.

Thus, it is believed that if an existing linear actuator is furnished with a device providing functions of lubricating and cooling, the problems about operative friction and noise can be solved and the maximum mechanical efficiency of the linear actuator can be achieved.

### SUMMARY OF THE INVENTION

The present invention has been accomplished under the circumstances in view to provide a lubricant-infusing device which comprises at least one lubricant-infusing point arranged at a linear actuator wherethrough a lubricant can be infused into the linear actuator.

It is one object of the present invention to provide a lubricant-infusing device, which facilitates ameliorating problems of operative friction and noise and accomplishing the maximum mechanical efficiency of the linear actuator.

It is another object of the present invention to provide a lubricant-infusing device, which can be designed as for manual or aromatic lubricant-infusing so that an operator can replenish lubricant timely as need.

It is a further object of the present invention to provide a lubricant-infusing device, which comprises an aromatic lubricant-infusing point communicated to a lubricant tank, so that lubricant-infusing can be executed automatically with preset rationing and timing.

It is yet another object of the present invention to provide a lubricant-infusing device, which requires uncomplex structure and small costs.

It is still another object of the present invention to provide a lubricant-infusing device, which facilitates ameliorating problems of operative friction and helps for extending the useful life of the linear actuator.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a block diagram of a transmission system equipped with a disclosed lubricant-infusing device of the present invention;

FIG. 2 is another block diagram of the transmission system equipped with the disclosed lubricant-infusing device according to the present invention;

FIG. 3 is a top view of a transmission system equipped with a disclosed lubricant-infusing device of the present invention;

FIG. 4 is a lateral view of the transmission system equipped with the disclosed lubricant-infusing device;

FIG. 5 is a schematic drawing showing the transmission system equipped with the disclosed lubricant-infusing device connected with a lubricant tank; and

FIG. 6 is an applied view showing the manual lubricant-infusing operation according to the present invention.

### DETAILED DESCRIPTION OF THE PREFERRED EMBODIMENT

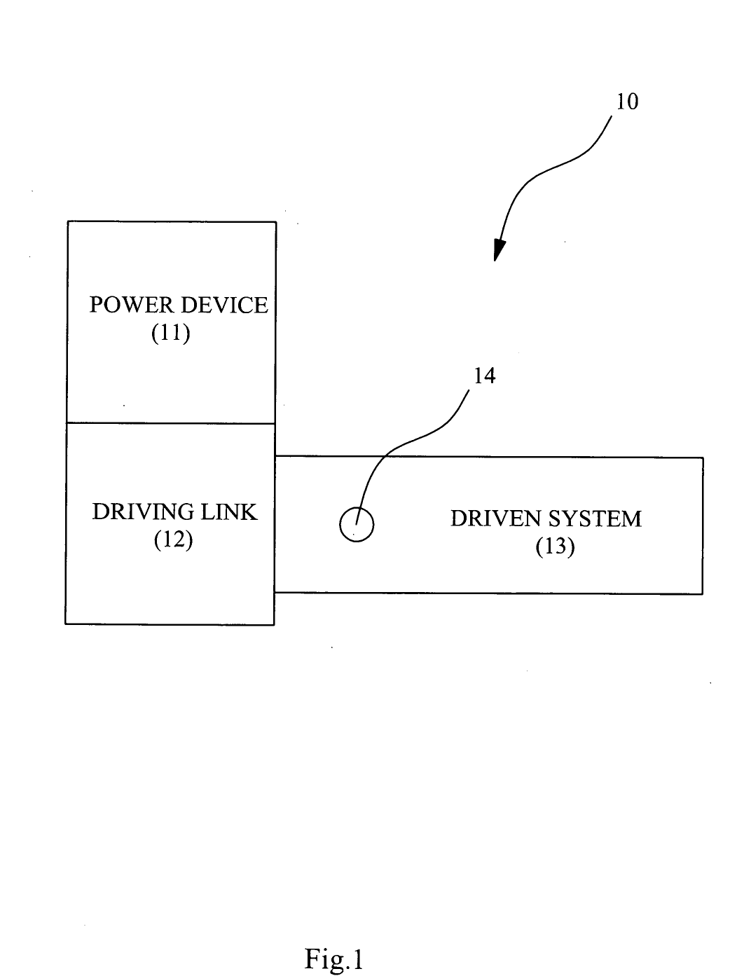

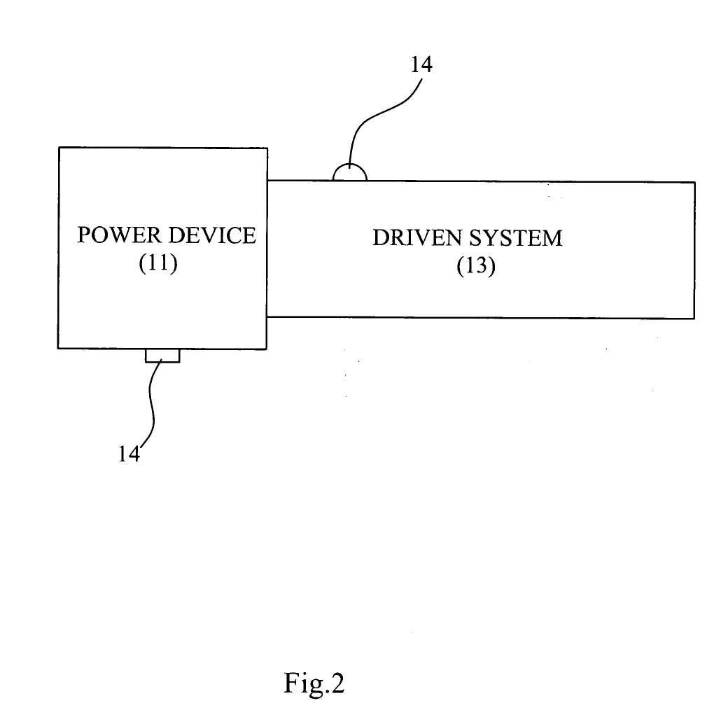

The concept of the present invention can be applied to a transmission system 10 which is comprising a power device 11, a driving link 12 and a driven system 13 as shown in FIGS. 1 and 2 wherein the driving link 12 is operatively connected to the power device 11 and for transmitting the motive power generated by the power device 11 to the driven system 13. A lubricant-infusing device according to the present invention comprises at least one lubricant-infusing point 14 provided on the driving link 12 at a location adjacent to the power device 11 wherethrough a lubricant can be infused to offer lubricant and cooling functions to the mechanism of the driven system.

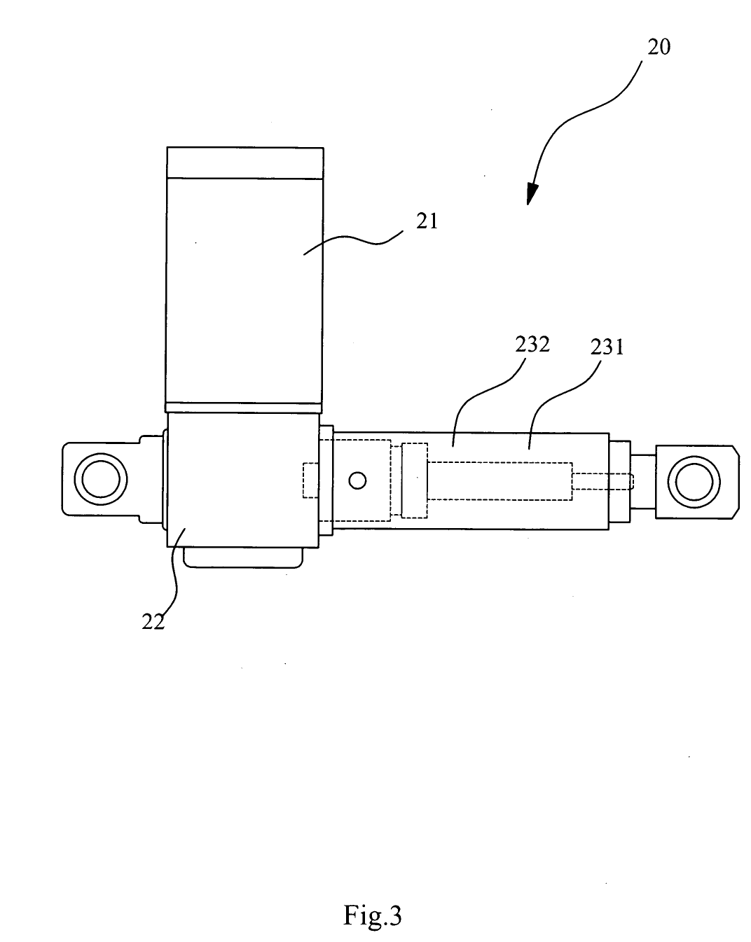

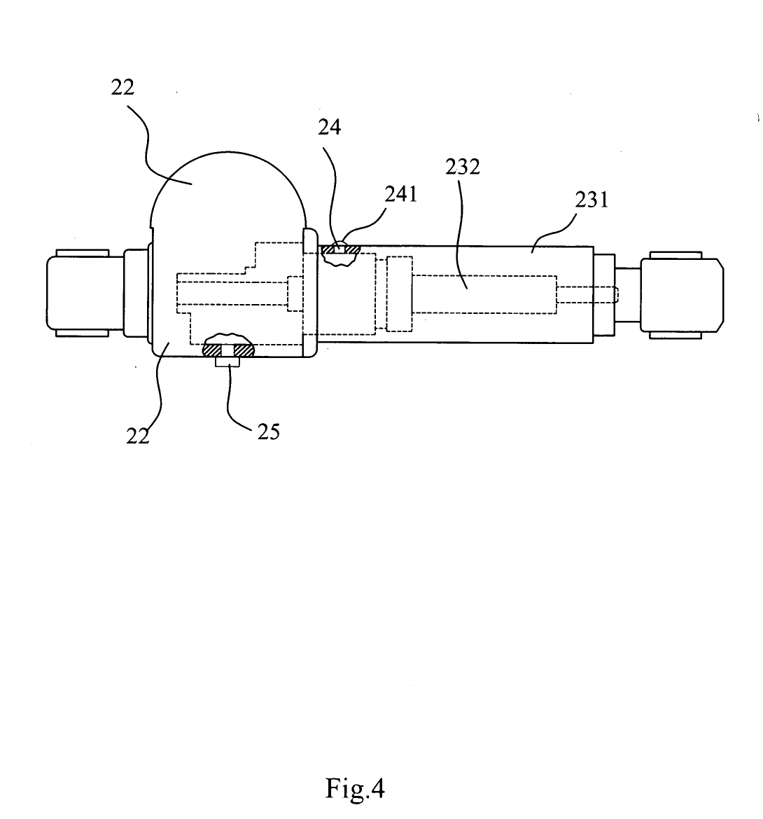

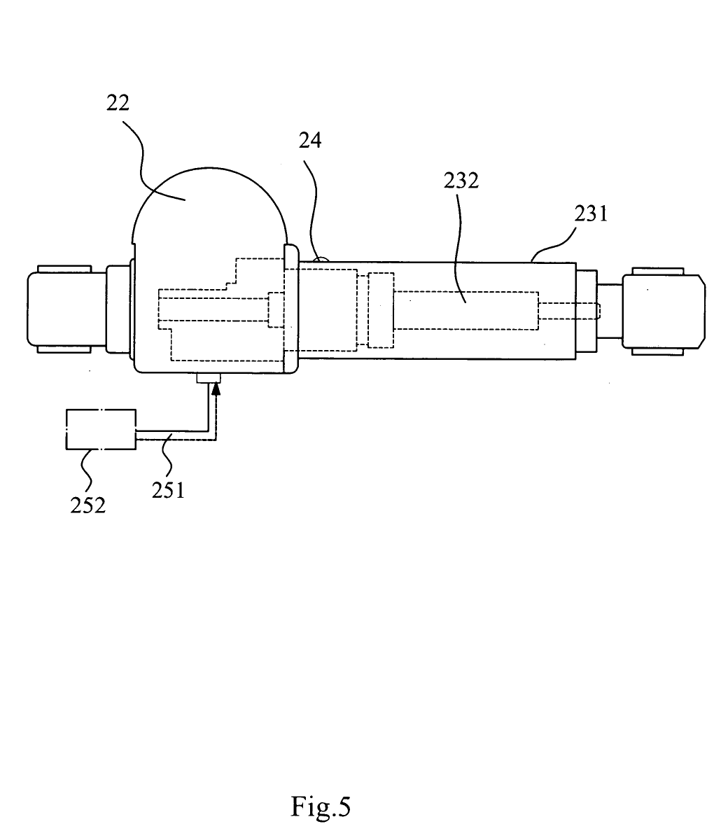

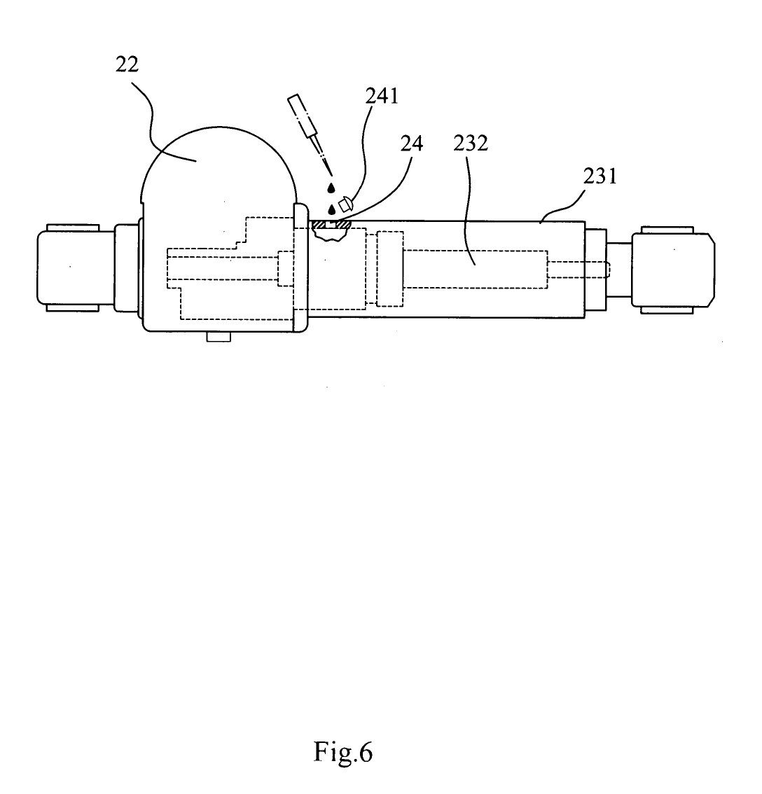

FIGS. 3, 4, 5 and 6 further describe one embodiment of the disclosed lubricant-infusing device assembled to a linear actuator 20 wherein the linear actuator 20 has a power device which can be a motor 21 according to this particular embodiment, a driving link which can be a gear box 22 operatively connected to the motor 21, and a driven system which can be a combination of a screw shaft 232 and an external tube 231 operatively connected to the gear box 22. The working principle of such a linear actuator 20 is that the motor 21 drives the mechanism in the gear box 22 to further propel the screw shaft 232 moving back and forth linearly along the external tube 231. The present invention comprises a plurality of lubricant-infusing point, which includes, as can be seen in the drawings, at least a manual lubricant-infusing point 24 positioned at the upper side of the external tube 231 and containing a detachable lid 241 so that a machine operator can remove the lid 241 and infuse a lubricant in to the external tube 231 manually, and at least one automatic lubricant-infusing point 25 positioned at the lower side of the gear box 22 and communicated with a lubricant tank 252 through a pipe 251 wherein a lubricant-infusing control element may be provided between the lubricant tank 252 and automatic lubricant-infusing point 25 for automatically infusing the lubricant into the linear actuator 20 according to preset rationing and timing values.

After the lubricant is infused into the linear actuator 20 form the lubricant-infusing point 24, 25, it can be distributed and smearing over the inner mechanism and the screw shaft 232 along with the movement of the screw shaft 232. Thereby, the present invention efficiently facilitates ameliorating problems of operative friction and noise and accomplishing the maximum mechanical efficiency and useful life of the linear actuator.

Although a particular embodiment of the invention has been described in detail for purposes of illustration, it will be understood by one of ordinary skill in the art that numerous variations will be possible to the disclosed embodiments without going outside the scope of the invention as disclosed in the claims.

What is claimed is:

1. A lubricant-infusing device for a linear actuator which comprises at least one lubricant-infusing point provided on the driving link at a location adjacent to the power device wherethrough a lubricant can be infused to offer lubricant and cooling functions to the mechanism of the driven system

2. The lubricant-infusing device as claimed in claim 1, wherein the lubricant-infusing point includes a detachable lid.

3. The lubricant-infusing device as claimed in claim 1, wherein the lubricant-infusing point is communicated with an external lubricant tank through a pipe.

4. The lubricant-infusing device as claimed in claim 3, wherein a lubricant-infusing control element may be provided between the lubricant tank and automatic lubricant-infusing point for automatically infusing the lubricant into the linear actuator according to preset rationing and timing values.
